(19) United States
(12) Patent Application Publication
(10) Pub. No.: US 2016/0118642 A1
(43) Pub. Date: Apr. 28, 2016

(54) METHOD FOR MANUFACTURING ELECTRODE AND ELECTRODE MANUFACTURING APPARATUS

(71) Applicant: TOYOTA JIDOSHA KABUSHIKI KAISHA, Toyota-shi (JP)

(72) Inventor: Katsushi ENOKIHARA, Toyota-shi (JP)

(73) Assignee: TOYOTA JIDOSHA KABUSHIKI KAISHA, Toyota-shi (JP)

(21) Appl. No.: 14/887,880

(22) Filed: Oct. 20, 2015

(30) Foreign Application Priority Data
Oct. 22, 2014 (JP) 2014-215425

(51) Int. Cl. H01M 4/04

(52) U.S. Cl. CPC H01M 4/0435

(57) ABSTRACT

A method for manufacturing an electrode including a base material and an electrode layer formed on the base material includes forming the electrode layer, or an electrode material layer that becomes the electrode layer in a subsequent process, by feeding an electrode material between paired first and second rolls that are rotatable and are arranged to be opposed to each other and feeding the base material onto a surface of the second roll so as to compress the electrode material fed between the first roll and the second roll and to cause the electrode material to adhere to the base material fed onto the surface of the second roll. The first and second rolls are used in combination, and the first roll has a surface rigidity smaller than a surface rigidity of the second roll.

### INCORPORATION BY REFERENCE

The disclosure of Japanese Patent Application No. 2014-215425 filed on Oct. 22, 2014 including the specification, drawings and abstract is incorporated herein by reference in its entirety.

### BACKGROUND OF THE INVENTION

1. Field of the Invention

The invention relates to a method for manufacturing an electrode, and an electrode manufacturing apparatus.

2. Description of Related Art

Nonaqueous electrolyte secondary batteries such as lithium ion secondary batteries are used in hybrid vehicles (HVs), plug-in hybrid vehicles (PHVs), electric vehicles (EVs) and the like. Nonaqueous electrolyte secondary batteries have a pair of electrodes formed of a positive electrode and a negative electrode, a separator that electrically isolates the electrodes, and a nonaqueous electrolyte. Electrodes for nonaqueous electrolyte secondary batteries (positive electrodes or negative electrodes) are typically constructed of a current collector made of metal foil or the like and an electrode layer containing an electrode active material (electrode active material layer) formed thereon.

A conventional method for manufacturing electrodes thus constructed includes the steps of forming an electrode layer, or an electrode material layer that becomes an electrode layer in a subsequent process, by feeding an electrode material between a first roll and a second roll which rotate in mutually opposite directions, compressing the electrode material and causing the electrode material to adhere to the surface of the second roll; and transferring the electrode layer or electrode material layer adhering to the surface of the second roll onto a base material (see, for example, claim 1 of Japanese Patent Application Publication No. 2013-077560 (JP 2013-077560 A)).

JP 2013-077560 A describes, as methods for causing the electrode material to adhere to the surface of the second roll, the method for providing a difference between the outer circumferential surface shapes of the first roll and the second roll; the method for using, as the first roll and the second roll, materials with different electrical conductivities, thermal conductivities, emissivities, thermal absorptivities, and the like; and the method for providing a difference between the rotational speeds or diameters of the first roll and the second roll (see paragraphs 0071 and 0072).

In this specification, the process of forming an electrode layer or an electrode material layer by compressing an electrode material that has been fed between a first roll and a second roll and causing the electrode material to adhere to the surface of the second roll is referred to as “roll forming.”

When preparing an electrode material, solid substances such as electrode active material are generally added in a granular (powdery) state. The electrode material includes one or two or more granular solid substances including an electrode active material, and, where necessary, one or two or more liquid ingredients. Here, “liquid ingredient” signifies an organic dispersion medium such as N-methyl-2-pyrrolidone (NMP) or an inorganic dispersion medium such as water. In the case where the electrode material includes a dispersion medium, the dispersion medium is ultimately (finally) removed by drying. When the electrode material does not include a dispersion medium, an electrode layer is formed on the surface of the second roll by roll forming. When the electrode material includes a dispersion medium, an electrode material layer containing the dispersion medium is formed on the surface of the second roll by roll forming. In the latter case, the dispersion medium is removed by drying in a subsequent process, as a result of which the electrode material layer becomes an electrode layer.

In the manufacturing method described in JP 2013-077560 A, the electrode material is compressed between the first roll and the second roll, and the compressed electrode material becomes an electrode layer or an electrode material layer and adheres to the surface of the second roll. At this time, in the electrode layer that is formed by compression and adherence to the surface of the second roll, the side closer to the surface of the second roll has a more densified structure, due to stress, such as shear force, which is caused between the first and second rolls. When this electrode layer or electrode material layer is transferred onto a base material, the more densified side of the electrode layer or electrode material layer becomes the surface side of the electrode layer ultimately (finally) obtained. Therefore, the resulting electrode layer has a structure with fewer voids between particles on the surface side, making it difficult for conductive ions such as lithium ions to penetrate to the interior of the electrode layer. In such a case, the ionic conductivity of the electrode layer decreases, worsening various battery characteristics.

Aside from the above methods, there exists a method that does not include a transfer process. In this method, an electrode material is fed between the first roll and the second roll and a base material is fed onto the surface of the second roll, the electrode material is compressed between the first roll and the second roll, and thus, an electrode layer or an electrode material layer is formed directly on the base material that has been fed onto the surface of the second roll. In this method, the side of the electrode layer or electrode material layer that is closer to the base material is more densified. Thus, it is possible to obtain an electrode layer having a larger number of voids between particles on the surface side. However, in this method, because the stress applied during compression of the electrode material acts directly on the base material made of metal foil or the like, substantial damage is caused to the base material, and thus, failure (breakage), flexing, creases or the like of the base material may readily occur. Particularly in the case where the solid content of the electrode material is high, since no dispersion medium is contained or the amount of dispersion medium is small, the working resistance (processing resistance) at a time when compressing and spreading the electrode material tends to become larger. Hence, as the solid content of the electrode material becomes higher, this problem becomes more noticeable.

Such a problem is not limited only to electrodes for nonaqueous electrolyte secondary batteries, and may occur in electrodes for any purposes which include a base material and an electrode layer formed on the base material.

### SUMMARY OF THE INVENTION

The invention provides a method for manufacturing an electrode, and an electrode manufacturing apparatus which can form an electrode layer having sufficient voids between particles on a surface side thereof, while reducing damage to a base material, regardless of the solid content of an electrode material.

A first aspect of the invention relates to a method for manufacturing an electrode including a base material and an electrode layer formed on the base material. The method includes forming the electrode layer, or an electrode material layer that becomes the electrode layer in a subsequent process, by feeding an electrode material between paired first and second rolls that are rotatable and are arranged to be opposed to each other and feeding the base material onto a surface of the second roll so as to compress the electrode material fed between the first roll and the second roll and to cause the electrode material to adhere to the base material fed onto the surface of the second roll. The first and second rolls are used in combination, and the first roll has a surface rigidity smaller than a surface rigidity of the second roll.

In the electrode manufacturing method according to the above-mentioned aspect of the invention, in the first and second rolls, the surface rigidity of the second roll on the side of the base material (on the base material-side) is made relatively large, and the surface rigidity of the first roll on the side of the electrode material (on the electrode material-side) is made relatively small. In this arrangement, the electrode layer or the electrode material layer obtained by roll forming has a structure in which the side close to the second roll having a relatively large surface rigidity, i.e., the base material-side is more greatly compressed and thus is dense with fewer voids between the particles. In this arrangement, the electrode layer or the electrode material layer obtained by roll forming has a structure in which the side close to the first roll having a relatively small surface rigidity, i.e., the surface side of the electrode layer or the electrode material layer, is less compressed and thus has more numerous voids between the particles.

In the electrode manufacturing method according to the above-mentioned aspect of the invention, by making the surface rigidity of the first roll on the electrode material-side relatively small, normal stress (perpendicular stress) between the first and second rolls is reduced. This lowers the stress that acts on the base material. Therefore, even when roll forming is carried out directly on the base material without carrying out a transfer process, damage to the base material is reduced. As a result, the occurrence of failure (breakage), flexing, creases or the like of the base material is suppressed.

In the electrode manufacturing method according to the above-mentioned aspect of the invention, due to these actions and effects, it is possible to form the electrode layer having sufficient voids between particles on the surface side thereof while reducing damage to the base material. The resulting electrode layer, viewed in the thickness direction, has a structure in which the voids between particles become more numerous from the base material-side toward the surface side (the number of the voids increases from the base material-side toward the surface side). Because the resulting electrode layer has sufficient voids between particles on the surface side, conductive ions such as lithium ions readily penetrate to the interior of the electrode layer, and as a result, the electrode layer has good ionic conductivity. Nonaqueous electrolyte secondary batteries which use this electrode layer have various good battery characteristics.

In general, as the solid content of the electrode material becomes higher, frictional force between the first roll and the electrode material tends to become larger, working resistance (processing resistance) at a time when compressing and spreading the electrode material tends to become larger and damage to the base material tends to increase. In the electrode manufacturing method according to the above-mentioned aspect of the invention, because the surface rigidity of the first roll on the electrode material-side is smaller, even when the electrode material has a high solid content, the frictional force between the first roll and the electrode material is reduced and the working resistance is reduced. Therefore, as the solid content of the electrode material becomes higher, the effect of reducing damage to the base material becomes more pronounced. In the electrode manufacturing method according to the above-mentioned aspect of the invention, the solid content of the electrode material may be 70 mass % or more.

When the electrode material includes granulated bodies, the frictional force between the first roll and the electrode material tends to increase and the working resistance at the time when compressing and spreading the electrode material tends to become relatively large. In the electrode manufacturing method of the invention, by making the surface rigidity of the first roll on the electrode material side relatively small, even when the electrode material contains granulated bodies, the frictional force between the first roll and the electrode material is reduced and the working resistance is reduced. Therefore, in the electrode manufacturing method according to the above-mentioned aspect of the invention, the effect of reducing damage to the base material is more pronounced when the electrode material contains granulated bodies. There is a possibility that a sufficient effect of reducing working resistance may not be obtained when the diameter of the granulated bodies is extremely large. The average diameter of granulated bodies may be 2 mm or less. That is, in the electrode manufacturing method according to the above-mentioned aspect of the invention, the electrode material may contain granulated bodies having an average diameter of 2 mm or less.

In the case where the solid content of the electrode material is relatively high or the electrode material contains granulated bodies, the working resistance at the time when compressing and spreading the electrode material tends to increase. In the case where the electrode material is appropriately compressed and spread between the first roll and the second roll, the thickness of the resulting electrode layer or electrode material layer becomes a value that is the same as or close to the distance between the rolls (inter-roll distance). Under the condition that the working resistance is high as described above, when the rotational speeds of the first and second rolls are identical, it is difficult to effectively compress and spread the electrode material fed between the first roll and the second roll, and thus, the resulting electrode layer or electrode material layer may become much thicker than the set value (the set inter-roll distance). Also, in this case, there is a possibility that the electrode material may remain thick between the first and second rolls, and the excess electrode material may cause deformation or the like in portions of the first roll having a relatively low surface rigidity, the portions coming into contact with the electrode material. This may cause failure (breakage), flexing, creases or the like of the base material.

The rotational speed of the second roll on the side where the electrode layer or the electrode material layer is formed by compression and adherence may be made higher than the rotational speed of the first roll. In this case, the electrode material fed between the first and second rolls is effectively spread by the second roll having a relatively high rotational speed. Therefore, even under the condition that the working resistance at the time when compressing and spreading the electrode material is large, the spreadability of the electrode material is improved and the electrode layer having the desired thickness can be stably obtained. Moreover, partial deformation of the first roll caused by excessively thick electrode material is suppressed, and thus, damage to the base material is reduced.

In the electrode manufacturing method according to the above-mentioned aspect of the invention, the rotational speed of the second roll may be set to be 2.5 to 30 times the rotational speed of the first roll. In this case, it is possible to effectively obtain the effect of improving spreadability of the electrode material 120M.

In the electrode manufacturing method according to the above-mentioned aspect of the invention, a roll having a surface with asperities may be used as the first roll. In the case where a roll having a surface with asperities is used as the first roll, when the electrode layer or the electrode material layer is formed on the base material that has been fed onto the second roll, the surface texture pattern (surface asperities pattern) of the first roll is transferred to the surface of the electrode layer or the electrode material layer.

Because the electrode layer with the surface texture pattern has a plurality of recesses on the surface, conductive ions such as lithium ions easily penetrate to the interior of the electrode layer via the recesses. As a result, the ionic conductivity of the electrode layer is improved, and thus, the various battery characteristics of the nonaqueous electrolyte secondary battery are improved.

A second aspect of the invention relates to an electrode manufacturing apparatus that manufactures an electrode including a base material and an electrode layer formed on the base material. The electrode manufacturing apparatus includes an electrode layer/electrode material layer forming device including paired first and second rolls that are rotatable and are arranged to be opposed to each other; an electrode material feeding device that feeds an electrode material between the first roll and the second roll; and a base material feeding device that feeds the base material onto a surface of the second roll. The electrode layer/electrode material layer forming device compresses the electrode material fed between the first roll and the second roll, and causes the electrode material to adhere to the base material fed onto the surface of the second roll so as to form the electrode layer or an electrode material layer that becomes the electrode layer in a subsequent process. The first roll has a surface rigidity smaller than a surface rigidity of the second roll.

In the electrode manufacturing apparatus according to the above-mentioned aspect of the invention, the solid content of the electrode material may be 70 mass % or more. The electrode material may contain granulated bodies having an average diameter of 2 mm or less. The second roll may have a rotational speed that is 2.5 to 30 times a rotational speed of the first roll. The first roll may be a roll having a surface with asperities.

According to the above-mentioned aspects of the invention, it is possible to provide the method for manufacturing an electrode and the electrode manufacturing apparatus which can form the electrode layer having sufficient voids between particles on the surface side thereof, while reducing damage to the base material, regardless of the solid content of the electrode material.

### BRIEF DESCRIPTION OF THE DRAWINGS

Features, advantages, and the technical and industrial significance of exemplary embodiments of the invention will be described below with reference to the accompanying drawings, in which like numerals denote like elements, and wherein:

FIG. 1A is a schematic overall view showing an example of the structure of a nonaqueous electrolyte secondary battery according to an embodiment of the invention;

FIG. 1B is a schematic sectional view of an electrode assembly in the nonaqueous electrolyte secondary battery in FIG. 1A;

FIG. 1C is a schematic sectional view of an electrode according to the embodiment of the invention;

FIG. 2A is a simplified view of an electrode manufacturing apparatus according to the embodiment of the invention;

FIG. 2B is a diagram showing a design modified example obtained by modifying the electrode manufacturing apparatus in FIG. 2A;

FIG. 2C is a diagram showing another design modified example obtained by modifying the electrode manufacturing apparatus in FIG. 2A;

FIG. 2D is a diagram showing yet another design modified example obtained by modifying the electrode manufacturing apparatus in FIG. 2A;

FIG. 3 is a diagram showing a design modified example obtained by modifying the first roll in the electrode manufacturing apparatus in FIG. 2A;

FIG. 4 is a diagram showing a modified example obtained by modifying the structure of the electrode in FIG. 1C.

FIG. 5A is a graph showing the relationship between the rotational speed ratio of the rolls and the thickness of the resulting electrode layer at varying inter-roll distances in the examples;

FIG. 5B is a graph showing the relationship between the rotational speed ratio of the rolls and the thickness of the resulting electrode layer at varying inter-roll distances in the examples;

FIGS. 6A and 6B are tables showing manufacturing conditions in each example and the mass, basis weight, thickness and density of an electrode layer produced.

### DETAILED DESCRIPTION OF EMBODIMENTS

The invention relates to art for manufacturing an electrode including a base material and an electrode layer formed on the base material, and specifically to a method for manufacturing the electrode and an electrode manufacturing apparatus. The electrode is not particularly limited. The invention can be applied to any electrode including a base material and an electrode layer formed on the base material. Examples of the electrode include electrodes for batteries. Examples of the battery include nonaqueous electrolyte secondary batteries such as lithium ion secondary batteries.

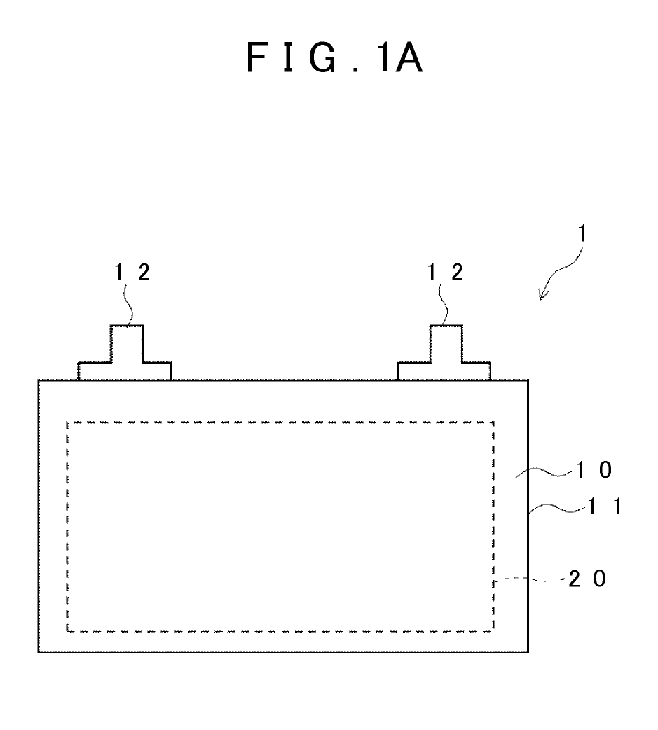

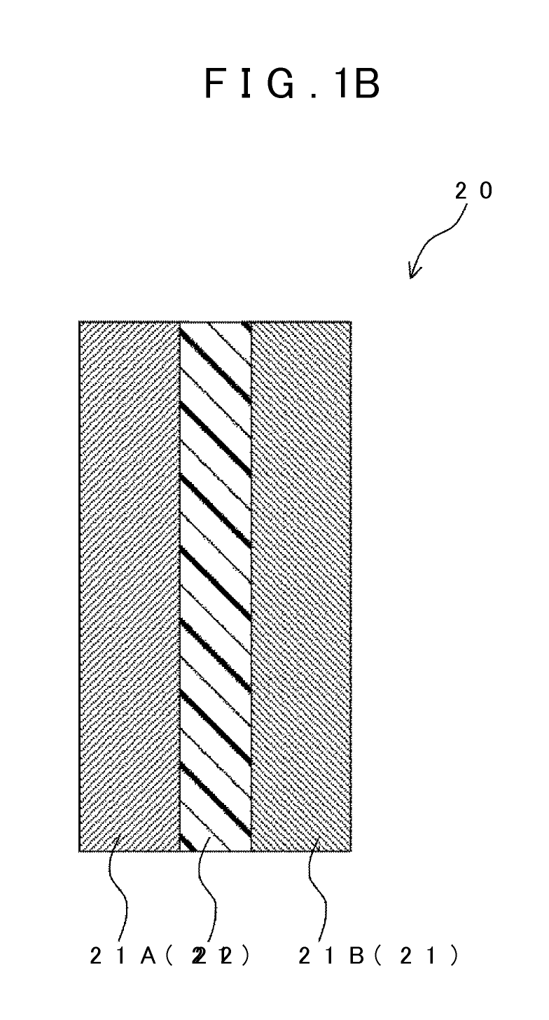

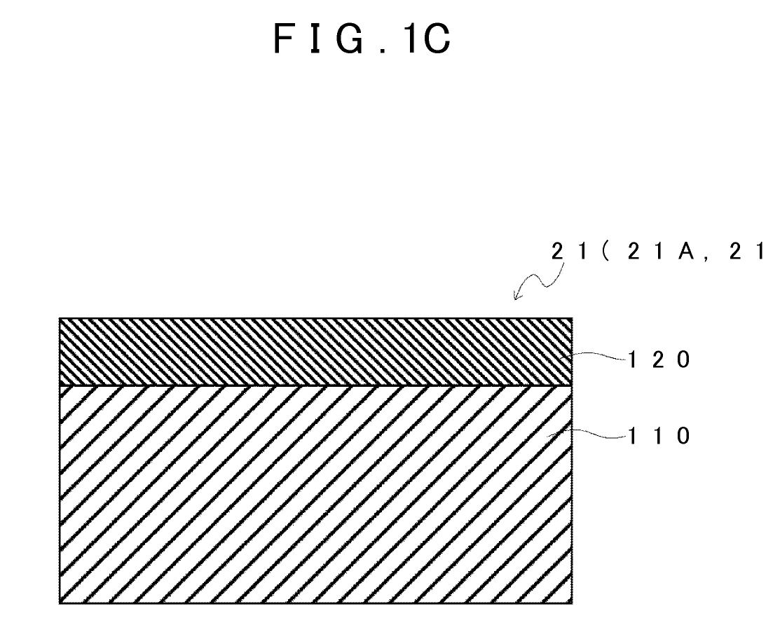

(Nonaqueous Electrolyte Secondary Battery) The configuration of a nonaqueous electrolyte secondary battery according to an embodiment of the invention is described with reference to the diagrams. FIG. 1A is a schematic overall view of a nonaqueous electrolyte secondary battery of the embodiment, FIG. 1B is a schematic sectional view of an electrode assembly, and FIG. 1C is a schematic sectional view of an electrode according to the embodiment of the invention. The electrode shown in the diagram is a positive electrode or negative electrode in a nonaqueous electrolyte secondary battery.

Referring to FIG. 1A, a nonaqueous electrolyte secondary battery 1 includes an electrode assembly 20 and a nonaqueous electrolyte (the reference numeral thereof is omitted) housed within an outer casing (battery enclosure) 11. Two external terminals (a positive terminal and a negative terminal) 12 for external connection are provided on an outside surface of the outer casing 11. As shown in FIG. 1B, the electrode assembly 20 is composed of a pair of electrodes 21 stacked together with an separator 22 therebetween that electrically isolates the electrodes. The pair of electrodes 21 is formed of a positive electrode 21A and a negative electrode 21B.

As shown in FIG. 1C, the electrode 21 (positive electrode 21A or negative electrode 21B) includes an electrode layer 120 formed on a base material 110. In this embodiment, the base material 110 is a current collector such as metal foil, and the electrode layer 120 is an electrode active material layer which includes an electrode active material.

Nonaqueous electrolyte secondary batteries are exemplified by lithium ion secondary batteries. The major constituent elements of a nonaqueous electrolyte secondary battery are described below using a lithium ion secondary battery as an example.

(Positive Electrode) A current collector such as aluminum foil may be preferably used as the base material. The positive electrode active material is not particularly limited. Examples include lithium-containing composite oxides such as LiCoO₂, LiMnO₂, LiMn₂O₄, LiNiO₂, LiNiₓCO₍₁₋ₓ₎O₂ and LiNiₓCo_{y}Mn_{(1-x-y)}O₂ (in the formulas, 0<x<1 and 0<y<1). The composition of the electrode material for the positive electrode active material layer is not particularly limited; suitable use may be made of a conventional composition. The electrode material for the positive electrode active material layer may include, for example, the above positive electrode active material and a binder such as polyvinylidene fluoride (PVDF). Where necessary, it may also include a conductive material such as carbon powder and a dispersion medium such as N-methyl-2-pyrrolidone (NMP).

(Negative Electrode) A current collector such as copper foil may be preferably used as the base material. The negative electrode active material is not particularly limited, with the use of one having a lithium intercalation ability at 2.0 V or less, vs. Li/Li⁺, being preferred. Examples of negative electrode active materials include carbonaceous materials such as graphite, transition metal oxides/transition metal nitrides/transition metal sulfides amenable to metallic lithium, lithium alloy and lithium ion doping and de-doping, and combinations thereof. The composition of the electrode material for the negative electrode active material layer is not particularly limited; suitable use may be made of a conventional composition. The electrode material for the negative electrode active material layer may include, for example, the above negative electrode active material and a binder such as styrene-butadiene copolymer (SBR). Where necessary, it may also include a thickener such as carboxymethylcellulose sodium salt (CMC), and a dispersion medium such as water.

(Nonaqueous Electrolyte) The nonaqueous electrolyte may be a conventional nonaqueous electrolyte. Use may be made of a nonaqueous electrolyte in the form of a liquid, gel or solid. For example, preferred use can be made of a nonaqueous electrolyte solution obtained by dissolving a lithium-containing electrolyte in a mixed solvent composed of a high-dielectric-constant carbonate solvent such as propylene carbonate or ethylene carbonate (EC) and a low-viscosity carbonate solvent such as diethyl carbonate, methyl ethyl carbonate or dimethyl carbonate (DMC). A mixed solvent such as EC/DMC/ethyl methyl carbonate (EMC) may be preferably used as the mixed solvent. Examples of lithium-containing electrolytes include lithium salts such as LiPF₆, LiBF₄, LiClO₄, LiAsF₆, Li₂SiF₆, LiOSO₂CₖF₍₂ₖ₊₁₎ (where k is an integer from 1 to 8) and LiPFₙ{CₖF₍₂ₖ₊₁₎}₍₆₋ₙ₎ (where n is an integer from 1 to 5, and k is an integer from 1 to 8), and combinations thereof.

(Separator) The separator should be a membrane which electrically isolates the positive electrode and the negative electrode and which is permeable to lithium ions. Preferred use may be made of a porous polymer film. Preferred examples of the separator include porous polyolefin films such as porous polypropylene (PP) films, porous polyethylene (PE) films, and porous laminated films of PP and PE.

(Outer Casing (Battery Enclosure)) A conventional outer casing may be used. Examples of the secondary battery include a cylindrical secondary battery, a coin-shaped secondary battery, a prismatic secondary battery, and a film-type secondary battery (a laminate-type secondary battery). The outer casing may be selected according to the desired battery shape (type).

(Electrode Manufacturing Method) The electrode manufacturing method of the invention includes forming the electrode layer, or an electrode material layer that becomes the electrode layer in a subsequent process, by feeding an electrode material between paired first and second rolls that are rotatable and are arranged to be opposed to each other and also feeding a base material onto a surface of the second roll so as to compress the electrode material fed between the first roll and the second roll and to cause the electrode material to adhere to the base material fed onto the surface of the second roll.

The electrode material may or may not include a dispersion medium (liquid ingredient). In the case where the electrode material does not include a dispersion medium, the electrode material is compressed and is caused to adhere to the base material, thereby forming an electrode layer. In the case where the electrode material includes a dispersion medium, the electrode material is compressed and is caused to adhere to the base material to form an electrode material layer containing the dispersion medium, after which the dispersion medium is removed by drying in a subsequent process, thereby forming an electrode layer.

The electrode manufacturing method of the invention uses the first and second rolls in a combination in which the first roll has a surface rigidity smaller than that of the second roll.

The surface rigidities of the first and second rolls can be adjusted using, for example, the surface material, the surface shape such as surface texturing (surface asperities), the existence or absence of surface treatment, the type of surface treatment, and combinations thereof. Hence, the surface materials, surface shape, existence or absence of surface treatment, type of surface treatment and the like are suitably selected such that the first roll has a surface rigidity smaller than that of the second roll.

The form of each of the first and second rolls is exemplified by a roll composed of a roll body (base material) alone, a roll composed of a roll body and a coating layer such as a resin layer that is formed on the roll body, and a roll composed of a roll body and a resin material such as a resin film or resin tape that is attached to, or bonded to the roll body. These rolls may be surface-treated. Hereinafter, “coating layer” and “coating material” are referred to collectively as “surface layer material.”

The surface rigidities of the first and second rolls can be evaluated in terms of the Young's modulus of the material at the roll surface. Alternatively, the surface rigidity can be evaluated in terms of the surface hardness. The surface hardness can be measured by the nanoindentation method or the like. Surface hardness measurement by nanoindentation or the like may be performed using a commercial microhardness tester. In the case where there is no surface layer material or the thickness of the surface layer material is so small as to be negligible relative to the thickness of the electrode layer, the surface rigidities of the first and second rolls are evaluated in terms of the rigidity of the roll body.

The resin material may be formed into a composite with the roll body by, for example, doping, dispersion or co-precipitation.

A first roll combination is exemplified by the combination of, as the first roll, a roll in which at least the surface is made of resin with, as the second roll, a roll in which at least the surface is made of metal or ceramic. The Young's modulus of resin is generally less than 10 GPa, that is, the Young's modulus of resin is generally in a range of approximately 1 GPa to approximately 5 GPa. The Young's modulus of a metal or ceramic is generally 100 GPa or more. For example, zirconia (ZrO₂), which is one type of ceramic, has a Young's modulus of approximately 250 GPa (literature value), and Teflon (a registered trademark) (polytetrafluoroethylene (PTFE)) has a Young's modulus of approximately 500 MPa (value measured by the inventor).

In this specification, unless otherwise specified, “metal” refers to a general-purpose metal, and does not include special materials such as cemented carbides having a higher hardness than general-purpose metals.

In the case of the first roll combination, the first roll is exemplified by a roll body alone that is made of resin, a metal or ceramic roll body on which a resin layer is formed, or a composite roll obtained by attaching, bonding, doping, dispersing or co-precipitating a resin material (e.g., a resin film or resin tape) on a metal or ceramic roll body. The first roll may be a roll that has been subjected to any of various conventional surface treatments.

It is preferable that the first roll should have a surface to which the electrode material does not readily adhere. If other conditions are the same, as the solid content of the electrode material becomes lower, the electrode material tends to adhere more easily to the surface of the first roll. In the case where the solid content of the electrode material is relatively low, it is preferable to design the first roll with small surface energy so as to suppress adherence of the electrode material to the first roll. Specifically, it is preferable that the surface of the first roll should have a contact angle with water of 90° or more. The surface energy of the first roll can be adjusted using the surface material, surface shape such as surface texture (surface asperities), existence or absence of surface treatment, and type of surface treatment on the first roll.

An example of a first roll to which the electrode material does not readily adhere is a roll that has been subjected to a conventional release treatment as surface treatment. In the case where the first roll has not been subjected to release treatment, it is preferable that at least the surface should be made of a fluorine-containing resin such as PTFE or a resin having excellent releasability such as a silicone resin. For example, preferred use can be made of a roll obtained by forming a resin layer made of the above resin having excellent releasability on a metal or ceramic roll body, or a composite roll obtained by attaching, bonding, doping, dispersing or co-precipitating a resin material (e.g., a resin film or resin tape) made of the above resin having excellent releasability on a metal or ceramic roll body. The first roll with the above-mentioned configuration has, as the overall roll, a sufficient strength and a sufficiently small surface rigidity, and the amount of electrode material adhering to the first roll is small, and thus, the first roll with the above-mentioned configuration is preferable. Moreover, the first roll with the above-mentioned configuration is less costly than the roll that is entirely made of a fluorine-containing resin or a silicone resin. Since the above-mentioned advantageous effects are obtained, the thickness of the resin layer or resin material made of a resin having excellent releasability is preferably 1 μm to 200 μm.

In the foregoing first roll combination, the second roll is exemplified by a roll body alone that is made of metal or ceramic, and a metal roll body which is coated with a material having a rigidity larger than that of the roll body by ceramic spraying or cemented carbide spraying.

This second roll combination is exemplified by a combination where the first roll is a roll in which at least the surface is made of metal and the second roll is a roll in which at least the surface is made of ceramic or cemented carbide. With this combination, the Young's modulus of the surface material in each of the rolls is 100 GPa or more, but the surface rigidity of the second roll is larger than the surface rigidity of the first roll.

In the second roll combination, the first roll is exemplified by a roll body alone that is made of metal. The second roll is exemplified by a roll body alone that is made of ceramic, a roll obtained by forming on a metal roll body a ceramic layer having a rigidity higher than that of the roll body by ceramic spraying or the like, and a roll obtained by forming on a metal roll body a cemented carbide layer having a rigidity higher than that of the roll body by cemented carbide spraying or the like. As in the first roll combination, it is preferable in the second roll combination that the electrode material should not readily adhere to the surface of the first roll. Therefore, the first roll may be subjected to a conventional release treatment as surface treatment.

In the above roll combinations, the first roll combination where the first roll is a roll in which at least the surface is made of resin and the second roll is a roll in which at least the surface is made of metal or ceramic is preferred because it is easy to impart a difference in the surface rigidities of the first and second roll and, moreover, a difference in the surface rigidities of the first and second rolls can be imparted at a low cost. In this case, as noted above, the Young's modulus of the surface material of the first roll may be set to less than 10 GPa, and the Young's modulus of the surface material of the second roll may be set to 100 GPa or more.

The electrode manufacturing method of this invention may be carried out using the subsequently described manufacturing apparatuses 2A to 2D according to the embodiment of the invention.

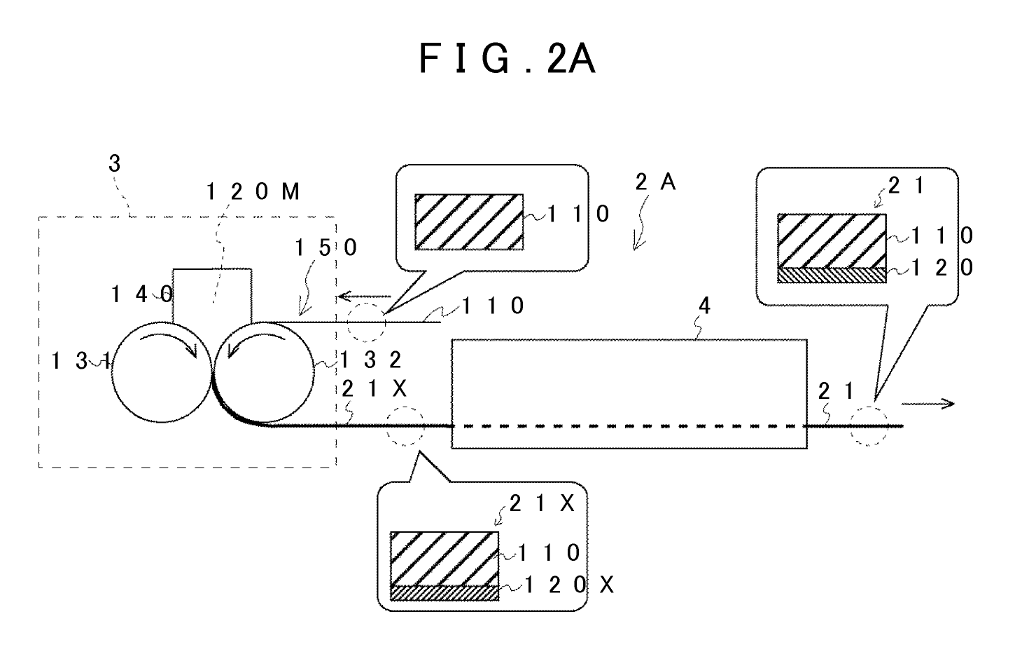

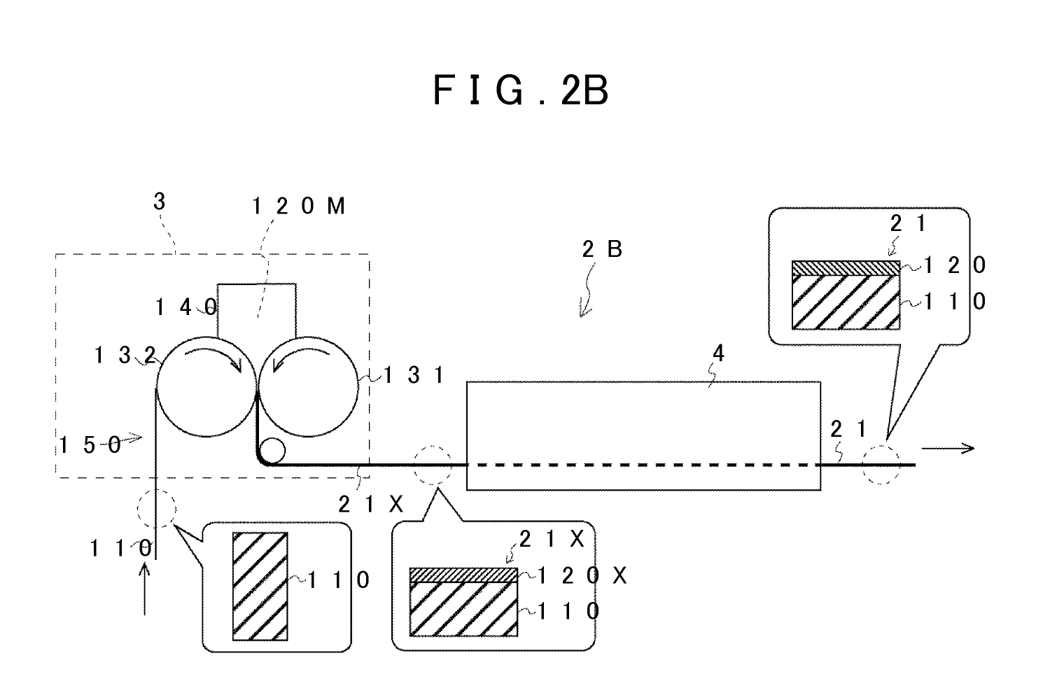

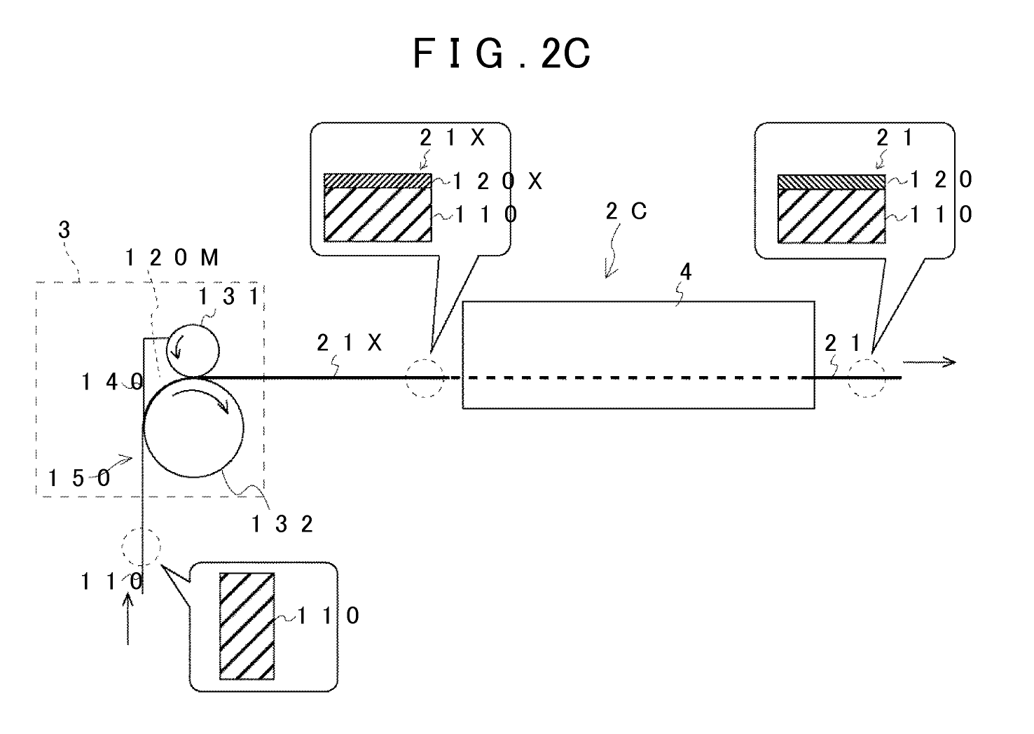

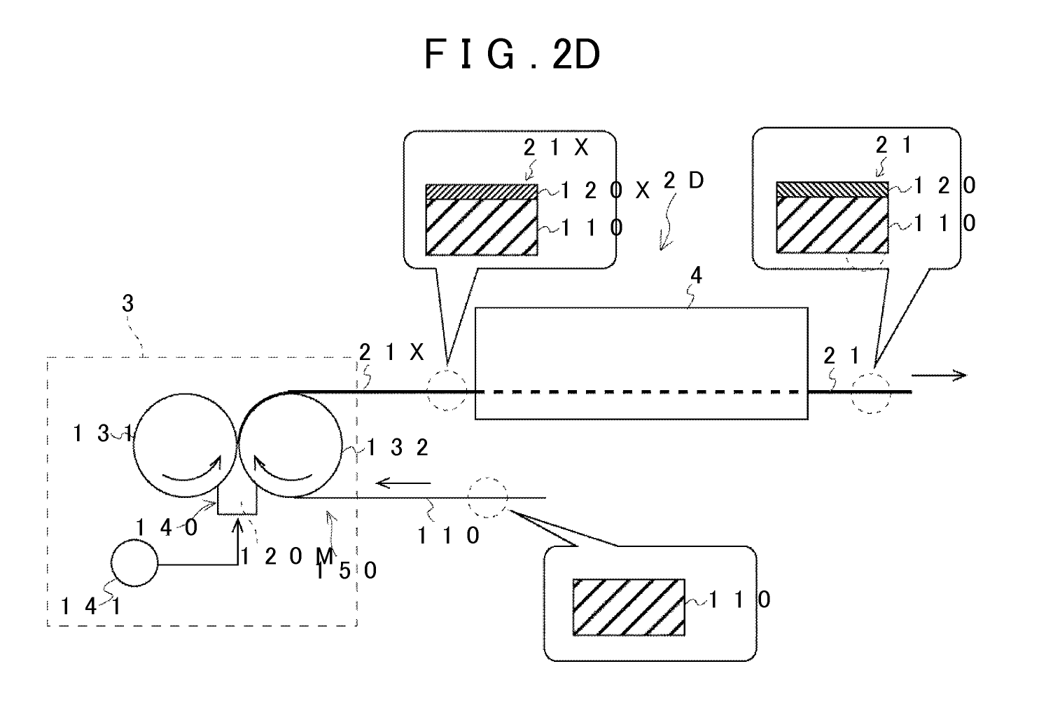

(Electrode Manufacturing Apparatus) Electrode manufacturing apparatuses according to the embodiment of the invention will be described with reference to the diagrams. A case, in which the electrode 21 (positive electrode 21A or negative electrode 21B) shown in FIG. 1C is manufactured, will be described. FIG. 2A is a schematic view of the electrode manufacturing apparatus according to the embodiment of the invention. FIGS. 2B to 2D are schematic views showing design modified examples obtained by modifying the electrode manufacturing apparatus in FIG. 2A. In FIGS. 2A to 2D, the vertical arrangement of the actual apparatuses corresponds to the vertical arrangement shown in the diagrams. In these diagrams, like reference symbols denote like elements.

Each of the electrode manufacturing apparatuses 2A to 2D shown in FIGS. 2A to 2D includes an electrode layer/electrode material layer forming device 3. The electrode layer/electrode material layer forming device is referred to below simply as an “electrode (material) layer-forming device.” The electrode (material) layer-forming device 3 includes paired first and second rolls 131, 132 that are rotatable and are arranged to be opposed to each other, an electrode material feeding device 140 that feeds an electrode material 120M between the first roll 131 and the second roll 132, and a base material feeding device 150 that feeds a base material 110 onto a surface of the second roll 132.

The electrode material feeding device 140 and the base material feeding device 150 are known devices. The illustrations of the electrode material feeding device 140 and base material feeding device 150 in the diagrams are schematic. Therefore, in the diagrams, the areas of these devices in the manufacturing apparatus are not clearly defined in the schematic diagrams, and accordingly, the area of the electrode (material) layer-forming device 3 within the manufacturing apparatus is not clearly defined in the schematic diagrams.

The electrode (material) layer-forming device 3 compresses the electrode material 120M that has been fed between the first roll 131 and the second roll 132 and causes the electrode material 120M to adhere to the base material 110 that has been fed onto the surface of the second roll 132, so as to form an electrode layer 120 or an electrode material layer 120X that becomes an electrode layer 120 in a subsequent process.

The electrode material feeding device 140 is selected according to the solid content of the electrode material 120M. A known device may be used as the electrode material feeding device 140. When the electrode material 120M has a relatively high solid content, the electrode material feeding device 140 may feed the electrode material 120M by a dry method. In such cases, as the electrode material feeding device 140, a hopper or the like may be used. When the electrode material 120M has a relatively low solid content, the electrode material feeding device 140 may feed the electrode material 120M by a wet method. In such cases, as the electrode material feeding device 140, a coating die or the like may be used. As described subsequently in detail, this invention is effective in the case where the electrode material 120M has a relatively high solid content.

Regardless of the solid content of the electrode material 120M, in the case where the electrode material 120M includes a dispersion medium (liquid ingredient), each of the electrode manufacturing apparatuses 2A to 2D further includes, at a stage subsequent to the electrode (material) layer-forming device 3, a drying unit 4 which removes the dispersion medium by drying. A known dryer may be used as the drying unit 4. Each of illustrative examples includes an infrared drying furnace which uses infrared light to perform heating and drying. Drying conditions such as the drying temperature are the same as for known methods. In this case, the electrode material layer 120X containing the dispersion medium is formed by roll forming, and in the drying process with the drying unit 4, the dispersion medium within the electrode material layer 120X is removed by drying. As a result, after the drying process with the drying unit 4, the electrode material layer 120X becomes the electrode layer 120.

In a case where the solid content of the electrode material 120M is 100 mass % (in a case in which no dispersion medium is included), there is no particular need for the drying unit 4. In this case, the electrode layer 120 is formed directly by roll forming.

FIGS. 2A to 2D show cases in which the electrode material 120M has a relatively high solid content but includes a dispersion medium. In these diagrams, the electrode material feeding device 140 is a hopper which feeds the electrode material 120M by a dry method. In these diagrams, the electrode material layer 120X is formed by roll forming, and after the drying process with the drying unit 4, the electrode material layer 120X becomes the electrode layer 120.

In this specification, “the case in which the electrode material 120M has a relatively high solid content” refers to the case in which, for example, the solid content is in a range of 70 mass % to 100 mass %. “The case in which the electrode material 120M has a relatively low solid content” refers to the case in which, for example, the solid content is less than 70 mass %.

As the base material feeding device 150, a known device may be used. An example of the base material feeding device 150 is a transporting system which includes a delivery roller that delivers the base material and one or more transporting rollers.

In the manufacturing apparatus 2A shown in FIG. 2A, the first roll 131 and the second roll 132 are arranged in the horizontal direction. In this example, the first roll 131 is situated on the left side in the diagram and the second roll 132 is situated on the right side. The electrode material feeding device 140 is disposed above the first roll 131 and the second roll 132. In this example, the electrode material 120M drops down from the electrode material feeding device 140 and is fed between the first roll 131 and the second roll 132. In this example, the base material 110 is fed from the right in the diagram to the upper end side of the second roll 132, the electrode material 120M is compressed onto the base material 110 and is caused to adhere to the base material 110 between the first roll 131 and the second roll 132, and a laminate 21X in which the electrode material layer 120X is formed on the base material 110 is sent out toward the right in the diagram from the bottom side of the second roll 132. The laminate 21X is transported to the drying unit 4 situated to the right of the first roll 131 and the second roll 132 in the diagram.

In the manufacturing apparatus 2B shown in FIG. 2B, the first roll 131 and the second roll 132 are arranged in the horizontal direction. In this example, the first roll 131 is situated on the right side in the diagram and the second roll 132 is situated on the left side. The base material 110 is fed from below to the left side of the second roll 132, the electrode material 120M is compressed onto the base material 110 and is caused to adhere to the base material 110 between the first roll 131 and the second roll 132, and the laminate 21X in which the electrode material layer 120X is formed on the base material 110 is sent out downward from the right side of the second roll 132. The direction of transport of the laminate 21X is changed to a direction toward the right side in the diagram by a transporting roller, and the laminate 21X is conveyed to the drying unit 4 situated to the right of the first roll 131 and the second roll 132 in the diagram.

In the manufacturing apparatus 2C shown in FIG. 2C, the first roll 131 having a diameter smaller than that of the second roll 132 is arranged over the second roll 132 with the center positions of both rolls vertically aligned. In this example, the electrode material feeding device 140 is situated above a portion of the second roll 132, the portion projecting out from the first roll 131. The electrode material 120M is fed between the first roll 131 and the second roll 132 from above the portion of the second roll 132, the portion projecting out from the first roll 131. In this example, the base material 110 is fed from below to the left side of the second roll 132 in the diagram, the electrode material 120M is compressed onto the base material 110 and is caused to adhere to the base material 110 between the first roll 131 and the second roll 132, and the laminate 21X in which the electrode material layer 120X is formed on the base material 110 is sent out toward the right in the diagram from the upper end side of the second roll 132. The laminate 21X is conveyed to the drying unit 4 situated to the right of the first roll 131 and the second roll 132 in the diagram.

In the manufacturing apparatus 2D shown in FIG. 2D, the first roll 131 and the second roll 132 are arranged in the horizontal direction. In this example, the first roll 131 is situated on the left side in the diagram and the second roll 132 is situated on the right side. The electrode material feeding device 140 is situated below the first roll 131 and the second roll 132; the electrode material 120M is fed between the first roll 131 and the second roll 132 from below using a pump 141. In this example, the base material 110 is fed from the right side in the diagram to the lower end side of the second roll 132, the electrode material 120M is compressed onto the base material 110 and is caused to adhere to the base material 110 between the first roll 131 and the second roll 132, and the laminate 21X in which the electrode material layer 120X is formed on the base material 110 is sent out toward the right in the diagram from the upper end side of the second roll 132. The laminate 21X is conveyed to the drying unit 4 situated to the right of the first roll 131 and the second roll 132 in the diagram.

The arrangements of the elements shown in the manufacturing apparatuses 2A to 2D are merely illustrative and appropriate design changes may be made to the arrangements.

In the electrode manufacturing apparatuses 2A to 2D, a roll combination in which the first roll 131 has a surface rigidity smaller than a surface rigidity of the second roll 132 is used as the combination of the first roll 131 and the second roll 132 (i.e., the first roll 131 and the second roll 132 are used in combination, and the first roll 131 has a surface rigidity smaller than a surface rigidity of the second roll 132). As mentioned above, the surface rigidities of the first roll 131 and the second roll 132 can be adjusted using, for example, the surface material, the surface shape, the existence or absence of surface treatment, the type of surface treatment, and combinations thereof. Therefore, the surface materials, surface shapes, existence or absence of surface treatment, type of surface treatment, and the like for these rolls are appropriately selected such that the surface rigidity of the first roll 131 is smaller than the surface rigidity of the second roll 132. Examples of combinations of the first roll 131 and the second roll 132 having different surface rigidities have been described above in the section “Electrode Manufacturing Method,” and the descriptions thereof are omitted here.

As mentioned above, in this embodiment, in the first roll 131 and the second roll 132, the second roll 132 on the side of the base material 110 has a relatively large surface rigidity and the first roll 131 on the side of the electrode material 120M has a relatively small surface rigidity. Since the first roll 131 and the second roll 132 have the above-mentioned configuration, in the electrode layer 120 or the electrode material layer 120X obtained by roll forming, a portion on the side of the second roll 132 having a relatively large surface rigidity, i.e., the base material 110-side is more greatly compressed, and thus, the portion (the base material 110-side) has a dense structure having fewer voids between the particles. Further, in the electrode layer 120 or the electrode material layer 120X, a portion on the side of the first roll 131 having a relatively small surface rigidity, i.e., the surface side of the electrode layer 120 or the electrode material layer 120X is less compressed, and thus the portion (the surface side) has a structure having more numerous voids between the particles.

In this embodiment, by making the surface rigidity of the first roll 131 on the side of the electrode material 120M relatively small, the normal stress (perpendicular stress) between the first roll 131 and the second roll 132 is reduced. This reduces the stress acting on the base material 110 that is made of metal foil or the like. Therefore, even when roll forming is carried out directly on the base material 110 without carrying out a transfer process, damage to the base material 110 is reduced. As a result, the occurrence of failure (breakage), flexing, creases or the like of the base material 110 is reduced.

Due to these advantageous effects, in this embodiment, the electrode layer 120 having sufficient voids between particles on the surface side can be formed while reducing damage to the base material 110. The resulting electrode layer 120 has a structure where, as seen in the thickness direction, voids between particles become more numerous from the base material 110-side toward the surface side (the number of voids between particles increases from the base material 110-side toward the surface side). Because the resulting electrode layer 120 has sufficient voids between particles on the surface side, conductive ions such as lithium ions readily penetrate to the interior of the electrode layer 120, as a result of which the electrode layer 120 has good ionic conductivity. The nonaqueous electrolyte secondary battery 1 that uses this electrode layer 120 thus has good battery characteristics.

The solid content of the electrode material 120M is not particularly limited. In general, as the solid content in the electrode material becomes higher, the frictional force between the first roll and the electrode material becomes greater, and working resistance (processing resistance) at a time when compressing and spreading the electrode material becomes greater, and damage to the base material tends to become greater. In this embodiment, by making the surface rigidity of the first roll 131 on the side of the electrode material 120M relatively small, even at a high solid content in the electrode material 120M, the frictional force between the first roll 131 and the electrode material 120M is reduced and the working resistance is reduced. Therefore, as the solid content in the electrode material 120M becomes higher, the effect of reducing damage to the base material 110 becomes more pronounced. Specifically, at a solid content in the electrode material 120M of 70 mass % or more (in a range of 70 mass % to 100 mass %), the effect of reducing damage to the base material 110 is more pronounced.

The electrode material 120M may include granulated bodies. Granulated bodies are bodies obtained by granulating one or two or more kinds of granular solid substances included in the electrode material. Granulated bodies are preferably used in, for example, cases where surface texture (surface asperities) is to be imparted to the electrode layer 120. When the electrode material 120M includes granulated bodies, the frictional force between the first roll 131 and the electrode material 120M tends to increase and the working resistance at the time when compressing and spreading the electrode material 120M tends to become relatively large. In this embodiment, by making the surface rigidity of the first roll 131 on the side of the electrode material 120M (on the electrode material 120M-side) relatively small, even in the case where the electrode material 120M includes granulated bodies, the frictional force between the first roll 131 and the electrode material 120M is reduced and the working resistance is reduced. Therefore, when the electrode material 120M includes granulated bodies, the effect of reducing damage to the base material 110 is more pronounced. However, when the diameter of the granulated bodies is excessively large, there is a possibility that a sufficient effect of reducing the working resistance may not be obtained. The average diameter of the granulated bodies is preferably 2 mm or less.

In this specification, the “average diameter” of the granulated bodies is the particle diameter at which the mass of particles larger than the median diameter D50 becomes 50% of the mass of all the particles, in the particle diameter distribution.

The rotational speeds of the first roll 131 and the second roll 132 may be the same or different. As noted above, in the case where the solid content of the electrode material 120M is relatively high or in the case where the electrode material 120M includes granulated bodies, the working resistance at the time when compressing and spreading the electrode material 120M tends to become larger. When the electrode material 120M is appropriately compressed and spread between the first roll 131 and the second roll 132, the thickness of the resulting electrode layer 120 or the electrode material layer 120X becomes a value that is the same as or close to the distance between the rolls (i.e., inter-roll distance). However, in cases such as the above where the working resistance is large, it is difficult to effectively compress and spread electrode material 120M that has been fed between the first roll 131 and the second roll 132 under the condition that the first roll 131 and the second roll 132 have the same rotational speed, and there is a possibility that the thickness of the resulting electrode layer 120 or the electrode material layer 120X may become much larger than the set value (set inter-roll distance). In such a case, the electrode material 120M may remain thick between the first roll 131 and the second roll 132, and excess electrode material 120M may cause deformation or the like in portions of the first roll 131 having a relatively small surface rigidity, the portion coming into contact with the electrode material 120M. This may cause failure (breakage), flexing, creases or the like of the base material 110.

It is preferable that the rotational speed of the second roll 132 on the side where the electrode layer 120 or the electrode material layer 120X is formed by compression and adherence should be faster than the rotational speed of the first roll 131. In such a case, the electrode material 120M fed between the first roll 131 and the second roll 132 is effectively spread by the second roll 132 having a relatively fast rotational speed. Therefore, even in cases like that mentioned above where the working resistance is large when compressing and spreading the electrode material 120M, the spreadability of the electrode material 120M improves and the electrode layer 120 with the desired thickness can be stably obtained. Moreover, partial deformation of the first roll 131 due to excessively thick electrode material 120M is suppressed, and thus, damage to the base material 110 is reduced.

The ratio of the rotational speed of the second roll to the rotational speed of the first roll (i.e., second roll rotational speed/first roll rotational speed, also referred to below as simply the “roll rotational speed ratio”) is preferably 2.5 or more, and more preferably 5.0 or more, because it is possible to obtain an advantageous effect of improving spreadability of the electrode material 120M. For reasons regarding the design of the apparatus, it is practical for the upper limit of the ratio of the second roll rotational speed to the first roll rotational speed (roll rotational speed ratio) to be 30, and more practical for the upper limit to be 25. That is, taking into consideration the spreadability of the electrode material 120M and practical design of the apparatus, the ratio of the second roll rotational speed to the first roll rotational speed (roll rotational speed ratio) is preferably from 2.5 to 30, more preferably from 5.0 to 30, and yet more preferably from 5.0 to 25.

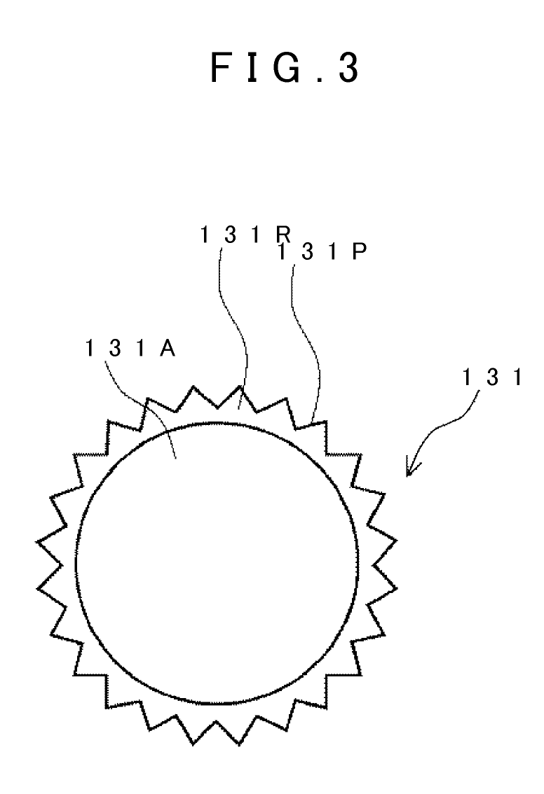

In this embodiment, as shown in FIG. 3, a roll having a surface with asperities (a roll with surface asperities, in other words, a surface-textured roll) may be used as the first roll 131. In the diagram, “131A” denotes the roll body, and “131P” denotes the surface texture pattern (surface asperities pattern). The first roll 131 shown in FIG. 3 can be produced by, for example, attaching or bonding a resin material 131R (resin film or resin tape, etc.) having the surface texture pattern 131P to the surface of the roll body 131A. The resin material 131R having the surface texture pattern 131P can be produced by, for example, using a mold having an inverse pattern of the surface texture pattern 131P to carry out pattern transfer by a process such as nanoimprinting onto a resin material or the like which does not have a surface pattern. An exemplary surface texture pattern is shown in the diagram, but suitable design changes may be made. The surface asperities are shown grossly exaggerated in the diagram. In reality, as described later in terms of surface roughness, the surface asperities are minute, and have a micrometer-order size or a nanometer-order size. Further, the diagram shows a schematic shape of the surface asperities.

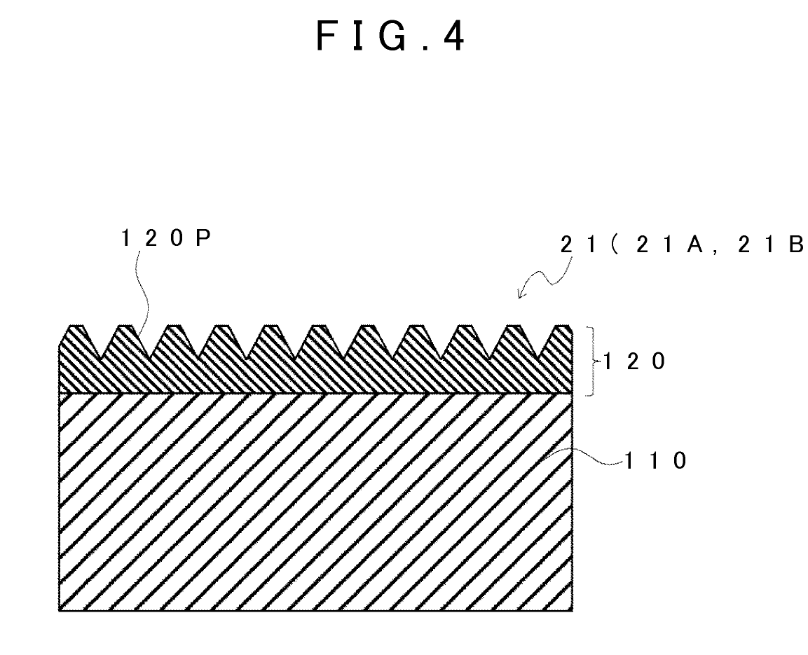

In the case where a surface-textured roll is used as the first roll 131, when the electrode layer 120 or the electrode material layer 120X is formed on the base material 110 that has been fed onto the second roll 132, the surface texture pattern 131P on the first roll 131 is transferred to the surface of the electrode layer 120 or the electrode material layer 120X. Hence, as shown in FIG. 4, for example, the electrode layer 120 having a surface texture pattern 120P corresponding to the surface texture pattern 131P on the first roll 131 is formed. The surface texture pattern 120P shown in FIG. 4 is schematic, as well as the surface texture pattern 131P shown in FIG. 3. The electrode layer 120 having the surface texture pattern 120P has a plurality of recesses on the surface. This facilitates the penetration of conductive ions such as lithium ions to the interior of the electrode layer 120 via the recesses. Therefore, as compared to the electrode layer 120 in FIG. 1C which does not have the surface texture pattern 120P, the ionic conductivity of the electrode layer 120 is improved, and thus, various battery characteristics of the nonaqueous electrolyte secondary battery are improved.

The degree of surface asperities in the surface texture pattern is not particularly limited. An exemplary indicator of the degree of surface asperities is the surface roughness Ra. Here, the surface roughness Ra is the “arithmetic mean roughness”, and can be measured using a commercial surface roughness tester. When the surface roughness Ra is extremely small, the surface texture-imparting effect (i.e., the effect of imparting the surface asperities) on the electrode layer or the electrode material layer by the surface-textured roll may be inadequate (insufficient). On the other hand, when the surface roughness Ra is extremely large, the electrode layer or the electrode material layer may be damaged. In this specification, “surface texture (surface asperities)” is defined as deliberately imparted surface texture having a surface roughness Ra of 0.1 μm or more. The surface roughness Ra of the surface-textured roll is preferably 0.1 to 10 μm.

In another method for imparting surface texture (surface asperities) to the electrode layer 120, the flat electrode layer 120 or the electrode material layer 120X is formed using a roll without surface asperities (a flat-surfaced roll) as the first roll 131, instead of using a surface-textured roll as the first roll 131, and then surface pattern transfer is carried out with a third roll having a surface texture pattern (not shown). In the case where the electrode material 120M includes a dispersion medium (liquid ingredient), surface pattern transfer with the use of the third roll is carried out before the drying process. Regardless of whether the first roll 131 has a surface texture, the first roll 131 is substantially circular in a cross-section and the entire first roll 131 has a curved surface. However, for the sake of convenience, a roll having no surface asperities is referred to as a “flat-surfaced roll” in order to distinguish it from a “surface-textured roll.”

In the case where the electrode layer 120 having the surface texture pattern 120P is produced, the electrode material 120M preferably includes granulated bodies having sufficient spreadability for roll forming and sufficient plasticity for shape memory for the surface asperities (i.e., sufficient plasticity for memorizing the shape of the surface asperities). The granulated bodies are formed by granulation of one or two or more kinds of granular solid substances included in the electrode material 120M. As already mentioned, when the diameter of the granulated bodies is extremely large, it may not be possible to obtain a sufficient effect of reducing the working resistance. The average diameter of the granulated bodies is preferably 2 mm or less. On the other hand, when the diameter of the granulated bodies is extremely small, it may not be possible to obtain a sufficient effect of memorizing the shape of the surface asperities. The average diameter of the granulated bodies is preferably 100 μm or more.

In order to obtain sufficient spreadability for roll forming and sufficient plasticity for imparting surface asperities to the electrode layer 120, it is preferable to use the following granulated bodies.

In the case where roll forming is carried out by a dry method, the granulated bodies preferably contain at least one kind of resin binder selected from the group consisting of heat-meltable binders (thermofusible binders) and photocurable binders. Heat-meltable binders are exemplified by PTFE binders. Photocurable binders are exemplified by ultraviolet (UV)-curable binders.

Heat-meltable binders have sufficient spreadability for roll forming and sufficient plasticity for imparting surface asperities to the electrode layer 120 or the electrode material layer 120X. In the case where a surface-textured roll is used to impart surface asperities to the electrode layer 120 or the electrode material layer 120X, the surface-textured roll may be warmed in order to melt or soften the heat-meltable binder, if necessary. Even when the surface-textured roll is not deliberately warmed, melting or softening of the heat-meltable binder may occur due to frictional heat generated between the surface-textured roll and the electrode material. After melting or softening, the heat-meltable binder is solidified upon returning to normal temperature. With the foregoing actions and effects, it is possible to achieve the effect of imparting the shape of surface asperities to the electrode layer 120 or the electrode material layer 120X and maintaining the shape.

Because a photocurable binder serves as a dispersion medium prior to curing, granulated bodies to which the photocurable binder has been added have sufficient spreadability for roll forming and sufficient plasticity for imparting surface asperities to the electrode layer 120 or the electrode material layer 120X. When a photocurable binder is used, after surface asperities have been imparted to the electrode layer 120 or the electrode material layer 120X, the binder is cured by exposure to light such as ultraviolet light (UV). With the foregoing actions and effects, it is possible to achieve the effect of imparting the shape of surface asperities to the electrode layer 120 or the electrode material layer 120X and maintaining the shape.

In the case where roll forming is carried out by a wet method, the granulated bodies are preferably undried granulated bodies containing a dispersion medium. Granulated bodies containing a dispersion medium have sufficient spreadability for roll forming and sufficient plasticity for imparting surface asperities to the electrode material layer 120X. However, when the concentration of the dispersion medium in the granulated bodies is extremely high, there is a possibility that surface asperities may not be appropriately imparted. The concentration of the dispersion medium in the granulated bodies is preferably 30 mass % or less. From the standpoint of having sufficient spreadability for roll forming and sufficient plasticity for imparting surface asperities to the electrode material layer 120X, the concentration of the dispersion medium in the granulated bodies is preferably 10 mass % to 30 mass %. The dispersion medium in the granulated bodies is removed during the process of drying the electrode material layer 120X. In the drying process, the electrode material layer 120X is solidified, and becomes the electrode layer 120. With the foregoing advantageous actions and effects, it is possible to achieve the effect of imparting the shape of surface asperities to the electrode layer 120 and maintaining the shape.

As described above, according to the embodiment, it is possible to provide methods for manufacturing the electrode 21 and the manufacturing apparatuses 2A to 2D which can form the electrode layer 120 having sufficient voids between particles on the surface side, while reducing damage to the base material 110, regardless of the solid content of the electrode material. According to the embodiment, the distribution of voids between particles in the thickness direction in the electrode layer 120 can be made suitable for the conduction of conductive ions such as lithium ions. As a result, batteries, such as nonaqueous electrolyte secondary batteries, which have various excellent battery characteristics can be provided.

Examples of the invention are described below.

### Examples 1 to 17

Electrodes were produced in examples 1 to 17 using the manufacturing apparatus as shown in FIG. 2A. In each of these examples, the negative electrode of a lithium ion secondary battery was produced. Copper foil was prepared as the base material. An electrode material having a solid content of 79 mass % and containing graphite (as the negative electrode active material), styrene-butadiene copolymer (SBR, as a binder), a small amount of carboxymethylcellulose sodium salt (CMC, as a thickener) and water (as a dispersion medium) was prepared. The SBR was added in the form of a latex. The amount of graphite was 95 mass % or more and the amount of binder was 5 mass % or less, with respect to 100 mass % of the overall solids in the electrode material. The electrode material included granulated bodies of graphite having an average diameter of 300 μm.

In each example, an electrode material layer was formed by feeding the electrode material between the first roll and the second roll using a wet method and feeding the base material onto the surface of the second roll, thereby compressing the electrode material fed between the first and second rolls and causing the electrode material to adhere to the base material that has been fed onto the surface of the second roll.

In each example, the following combination of rolls was used as the combination of the first roll and the second roll. A PTFE/ZrO₂ roll obtained by bonding 200 μm-thick Teflon (a registered trademark) (PTFE) tape (not subjected to any special treatment for imparting surface asperities; Ra is less than 0.1 μm) to a zirconia (ZrO₂) roll body was used as the first roll. A ZrO₂ roll formed of a zirconia (ZrO₂) roll body alone was used as the second roll. In this roll combination, the surface rigidity of the first roll is smaller than the surface rigidity of the second roll. Specifically, zirconia (ZrO₂) has a Young's modulus of approximately 250 GPa (literature value), and Teflon (the registered trademark) (PTFE) has a Young's modulus of approximately 500 MPa (value measured by the inventor).

After the electrode material layer was formed on the base material by roll forming (i.e., after the electrode material layer was formed on the base material with the use of the rolls) as described above, the electrode material layer was dried by a known method using an infrared drying furnace, thereby forming an electrode layer.

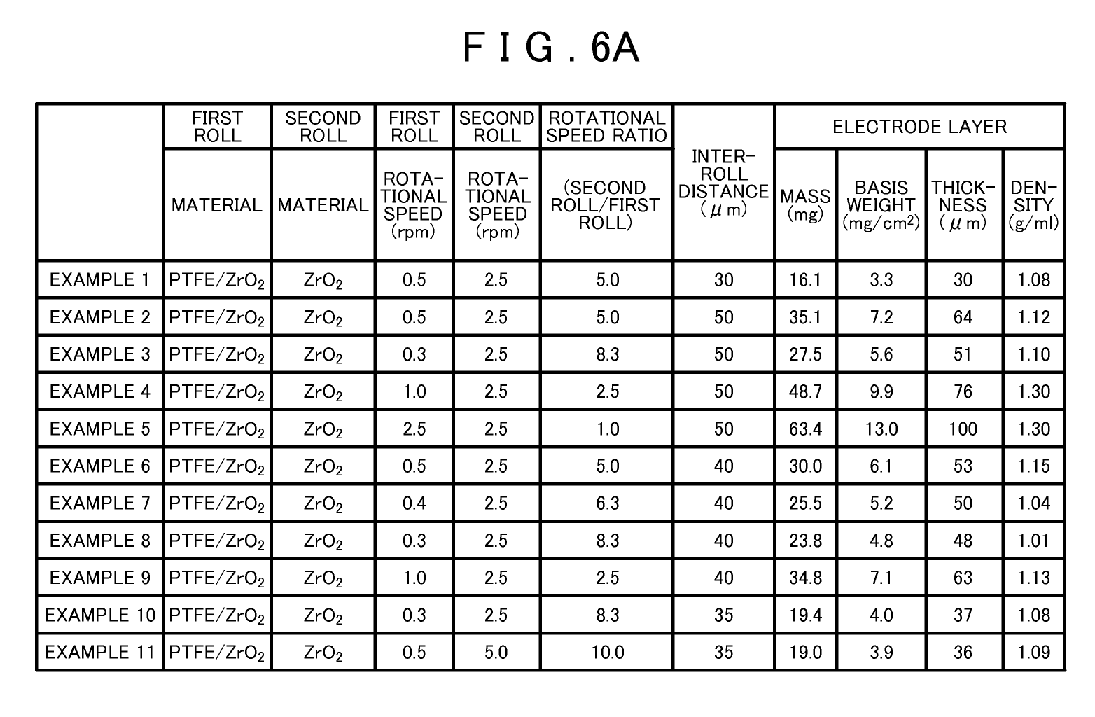

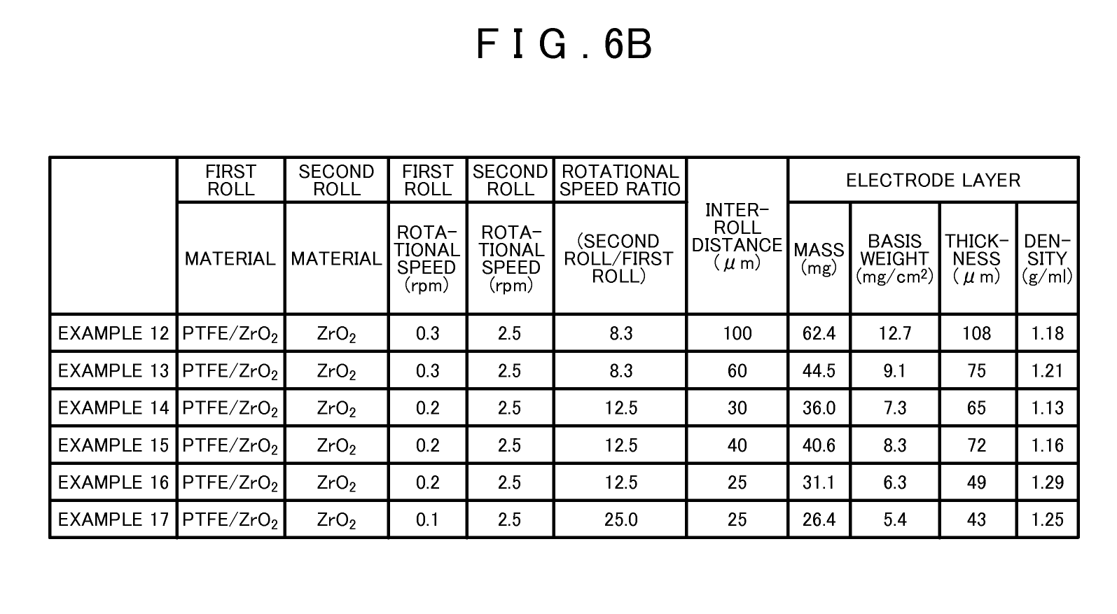

In Examples 1 to 17, electrodes were produced by varying the rotational speeds (rpm) of the first roll and the second roll, the ratio of the rotational speed of the second roll to the rotational speed of the first roll (rotational speed ratio of rolls), and the distances between the first and second rolls (inter-roll distance), and keeping the other conditions the same. FIGS. 6A and 6B show the manufacturing conditions in each example and the mass, basis weight, thickness and density of the electrode layer produced.

In each example, the “mass of the electrode layer” is the average value for two samples. Similarly, in each example, the “thickness of the electrode layer” is the average value for two to eight samples. The thickness of the electrode layer was determined by measuring the thickness of the entire electrode including the current collector, and then subtracting the thickness of the current collector.

The cross-sections of the electrode layers obtained in the respective examples were examined using a scanning electron microscope (SEM). In Examples 1 to 17 which used, as the combination of the first roll and the second roll, a roll combination in which the surface rigidity of the first roll was smaller than the surface rigidity of the second roll, each of the resulting electrode layers had a dense structure with relatively few voids between particles on the base material-side (corresponding to the second roll-side), and had a structure with relatively numerous voids between particles on the surface side (corresponding to the first roll-side). Defects such as failure (breakage), flexing, creases and the like were not observable in the base materials of any of the examples.

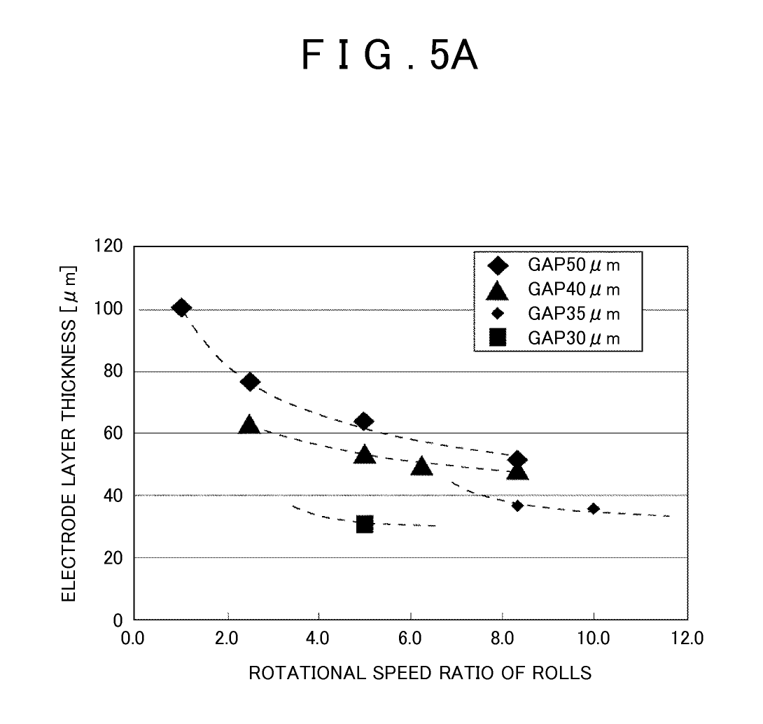

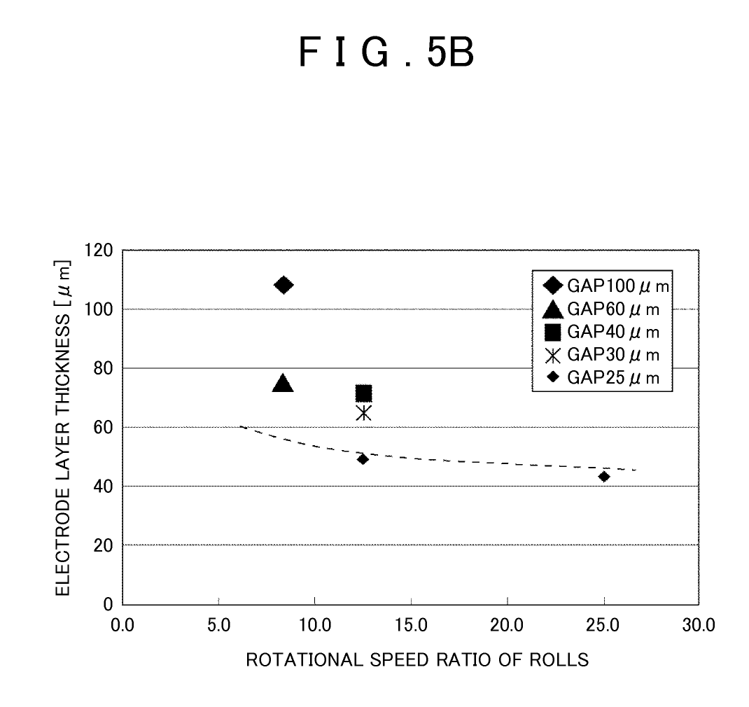

FIGS. 5A and 5B show the relationship between the rotational speed ratio of the rolls and the thickness of the resulting electrode layer at varying inter-roll distances. In FIGS. 5A and 5B, “GAP” signifies the inter-roll distance (the roll gap, that is, the distance between the rolls). Basically, in the case where the electrode material is appropriately compressed and spread between the first roll and the second roll, the thickness of the resulting electrode layer becomes a value equal to or close to the inter-roll distance. In Examples 1 to 17, because the electrode materials used have a solid content of 70 mass % or more and include also granulated bodies, compression and spreading work by a conventional method is difficult. As shown in FIG. 5A, under the condition that the rotational speed of the first roll and the rotational speed of the second roll are identical (rotational speed ratio of roll is 1), the thickness of the electrode layer has become larger than the inter-roll distance (Example 5). In FIGS. 5A and 5B, as the ratio of the rotational speed of the second roll to the rotational speed of the first roll (rotational speed ratio of the rolls) becomes larger, the thickness of the electrode layer becomes closer to a set value (set inter-roll distance). It is apparent from FIGS. 5A and 5B that the rotational speed ratio of the second roll to the first roll (rotational speed ratio of the rolls) is preferably 2.5 or more, and more preferably 5.0 or more. In terms of apparatus design, it is practical for the upper limit of the rotational speed ratio of the second roll to the first roll (rotational speed ratio of the rolls) to be 30, and more practical for the upper limit to be 25. The rotational speed ratio of the second roll to the first roll (roll rotational speed ratio) is preferably 2.5 to 30, more preferably 5.0 to 30 and particularly preferably 5.0 to 25.

What is claimed is:

1. A method for manufacturing an electrode including a base material and an electrode layer formed on the base material, the method comprising
forming the electrode layer, or an electrode material layer that becomes the electrode layer in a subsequent process, by feeding an electrode material between paired first and second rolls that are rotatable and are arranged to be opposed to each other and feeding the base material onto a surface of the second roll so as to compress the electrode material fed between the first roll and the second roll and to cause the electrode material to adhere to the base material fed onto the surface of the second roll, wherein the first and second rolls are used in combination, and the first roll has a surface rigidity smaller than a surface rigidity of the second roll.

2. The method according to claim 1, wherein the electrode material has a solid content of 70 mass % or more.

3. The method according to claim 1, wherein the electrode material includes granulated bodies having an average diameter of 2 mm or less.

4. The method according to claim 1, wherein a rotational speed of the second roll is set to be 2.5 to 30 times a rotational speed of the first roll.

5. The method according to claim 1, wherein a roll having a surface with asperities is used as the first roll.

6. An electrode manufacturing apparatus that manufactures an electrode including a base material and an electrode layer formed on the base material, the electrode manufacturing apparatus comprising
an electrode layer/electrode material layer forming device including:
paired first and second rolls that are rotatable and are arranged to be opposed to each other;
an electrode material feeding device that feeds an electrode material between the first roll and the second roll; and
a base material feeding device that feeds the base material onto a surface of the second roll, wherein:
the electrode layer/electrode material layer forming device compresses the electrode material fed between the first roll and the second roll, and causes the electrode material to adhere to the base material fed onto the surface of the second roll so as to form the electrode layer or an electrode material layer that becomes the electrode layer in a subsequent process; and
the first roll has a surface rigidity smaller than a surface rigidity of the second roll.

7. The electrode manufacturing apparatus according to claim 6, wherein the electrode material has a solid content of 70 mass % or more.

8. The electrode manufacturing apparatus according to claim 6, wherein the electrode material includes granulated bodies having an average diameter of 2 mm or less.

9. The electrode manufacturing apparatus according to claim 6, wherein the second roll has a rotational speed that is 2.5 to 30 times a rotational speed of the first roll.

10. The electrode manufacturing apparatus according to claim 6, wherein the first roll is a roll having a surface with asperities.
